(19) United States
(12) Patent Application Publication
(10) Pub. No.: US 2026/0172814 A1
(43) Pub. Date: Jun. 18, 2026

(54) Methods And Apparatus For Multi-Subscriber Identity Module Data Transmission For User Equipment Grouping In Mobile Communications

(71) Applicant: MediaTek Inc., Hsinchu City (TW)

(72) Inventors: Kun-Lin Wu, Hsinchu City (TW); Sheng-Yi Ho, Hsinchu City (TW); Kuo-Chun Lee, San Jose, CA (US); Keng-Ming Huang, Hsinchu City (TW)

(73) Assignee: MediaTek Inc., Hsinchu City (TW)

(21) Appl. No.: 19/396,412

(22) Filed: Nov. 21, 2025

Related U.S. Application Data
(60) Provisional application No. 63/734,231, filed on Dec. 16, 2024.

(51) Int. Cl. H04W 8/22; H04W 68/02; H04W 80/06

(52) U.S. Cl. CPC H04W 8/22; H04W 68/02; H04W 80/06

(57) ABSTRACT

Various solutions for multi-subscriber identity module (SIM) data transmission with respect to an apparatus and a network are described. An apparatus may transmit a remote user equipment (UE) notification to a network node through a first SIM of the apparatus. The apparatus may transmit a relay UE notification to the network node through a second SIM of the apparatus. The apparatus may perform a data service with the network node through the first SIM and the second SIM.

### CROSS REFERENCE TO RELATED PATENT APPLICATION(S)

The present disclosure is part of a non-provisional application claiming the priority benefit of U.S. Patent Application No. 63/734,231, filed 16 Dec. 2024, the content of which is herein incorporated by reference in its entirety.

### TECHNICAL FIELD

The present disclosure is generally related to mobile communications and, more particularly, to multi-subscriber identity module (SIM) data transmission for user equipment (UE) grouping with respect to an apparatus and a network node in mobile communications.

### BACKGROUND

Unless otherwise indicated herein, approaches described in this section are not prior art to the claims listed below and are not admitted as prior art by inclusion in this section.

Wireless communication systems may be widely deployed to provide various telecommunication services such as telephony, video, data, messaging, and broadcasts. Typical wireless communication systems may use multiple-access technologies capable of supporting communication with multiple users by sharing available system resources. Examples of such multiple-access technologies may include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

In conventional communication technologies, the user equipment (UE) aggregation or UE grouping must be performed through different devices, e.g., a remote UE and a relay UE. Such a framework needs two devices and a local link between the two devices for data forwarding. Additional frequency resources (e.g., Wi-Fi or unlicensed bands) are also necessary for the local link communication. This will result in high costs and complexity for UE aggregation or UE grouping.

Accordingly, how to realize the UE aggregation or UE grouping through an apparatus with multi-SIM function becomes an important issue for the newly developed wireless communication network. Therefore, there is a need to provide proper schemes for multi-SIM data transmission.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods, and apparatus pertaining to multi-SIM data transmission for UE grouping with respect to an apparatus and a network node in mobile communications. It is believed that the above-described issue would be avoided or otherwise alleviated by implementing one or more of the proposed schemes described herein.

In one aspect, a method may involve an apparatus transmitting a remote UE notification to a network node through a first SIM of the apparatus. The method may also involve the apparatus transmitting a relay UE notification to the network node through a second SIM of the apparatus. The method may further involve the apparatus performing a data service with the network node through the first SIM and the second SIM.

In another aspect, a method may involve a network node receiving a remote UE notification from a first SIM of a UE. The method may also involve the network node receiving a relay UE notification from a second SIM of the UE. The method may further involve the network node performing a data service with the UE according to the remote UE notification and the relay UE notification.

In another aspect, an apparatus may involve a first SIM and a second SIM. The apparatus may also involve a transceiver which, during operation, wirelessly communicates with at least one network node of a wireless network. The apparatus may further involve a processor communicatively coupled to the transceiver such that, during operation, the processor may transmit, via the transceiver, a remote UE notification to a network node through a first SIM. The processor may also transmit, via the transceiver, a relay UE notification to the network node through the second SIM. The processor may further perform a data service with the network node through the first SIM and the second SIM.

It is noteworthy that, although description provided herein may be in the context of certain radio access technologies, networks and network topologies such as 5^{th} Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), 6th Generation (6G), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario for multi-SIM data service transmission in accordance with implementations of the present disclosure.

FIG. 3 is a diagram depicting an example scenario for multi-SIM paging service transmission in accordance with implementations of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of an example process in accordance with another implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes, and/or solutions pertaining to multi-SIM data transmission for UE grouping with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

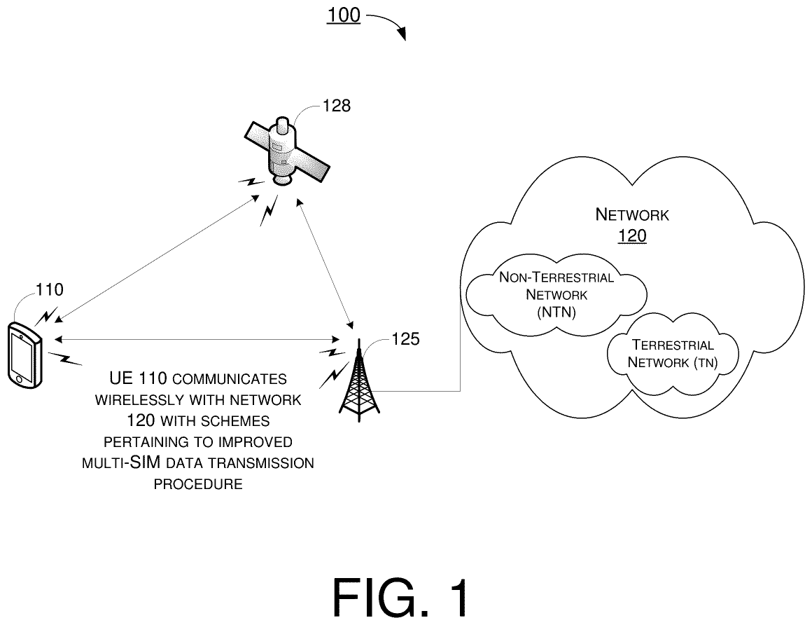

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form a non-terrestrial network (NTN) serving cell for wireless communication with the UE 110. In some implementations, the UE 110 may be an IoT device such as an NB-IoT UE or an enhanced machine-type communication (eMTC) UE (e.g., a bandwidth reduced low complexity (BL) UE or a coverage enhancement (CE) UE). The UE 110 may be equipped with multiple SIMs and support multi-SIM (or dual-SIM) functions. In such a communication environment, the UE 110, the network 120, the terrestrial network node 125, and the non-terrestrial network node 128 may implement various schemes pertaining to improved multi-SIM data transmission procedure in accordance with the present disclosure, as described below. It is noteworthy that, while the various proposed schemes may be individually or separately described below, in actual implementations, some or all of the proposed schemes may be utilized or otherwise implemented jointly. Of course, each of the proposed schemes may be utilized or otherwise implemented individually or separately.

According to the implementations of the present disclosure, an apparatus (e.g., UE 110) may transmit a remote UE notification to a network node (e.g., terrestrial network node 125 or non-terrestrial network node 128) through a first SIM of the apparatus. In addition, the apparatus may transmit a relay UE notification to the network node through a second SIM of the apparatus. Then, the apparatus may perform a data service with the network node through the first SIM and the second SIM. That is, the first SIM and the second SIM may perform the data service with the network node in the same apparatus (e.g., UE).

According to the implementations of the present disclosure, the remote UE notification may comprise a capability of a remote UE function, and the relay UE notification may comprise a capability of a relay UE function. That is, the first SIM of the apparatus can be considered a remote UE, and the second SIM of the apparatus can be considered a relay UE. Specifically, the first SIM may establish the RRC connection between the first SIM and the network node to report the remote UE notification, including the capability of the remote UE function, to the network node. Additionally, the second SIM may establish the RRC connection between the second SIM and the network node to report the relay UE notification, including the capability of the relay UE function, to the network node. Therefore, in the implementations of the present disclosure, the functions of the remote UE and the relay UE can be realized in an apparatus. The remote UE (e.g., first SIM) and the relay UE (e.g., second SIM) do not need to communicate with each other through an air message/interface in a wireless network (e.g., Wi-Fi).

According to an implementation of the present disclosure, the apparatus may trigger UE assisting information transmission through the first SIM to transmit relay UE relevant information to the network node.

According to an implementation of the present disclosure, the network node may perform an RRC reconfiguration to the second SIM to establish a relaying data radio bearer (DRB) for the second SIM to start the data service.

According to an implementation of the present disclosure, the apparatus may perform a data traffic (or application (APP) data traffic) aggregation, a data traffic (or APP data traffic) steering, or a data traffic (or APP data traffic) switch through a modem (MD)-based multipath-transmission control protocol (MP-TCP) or multipath-quick user-datagram-protocol (UDP) internet connections (MP-QUIC) to separate the data traffic (or APP data traffic) to the first SIM and the second SIM. In another implementation of the present disclosure, the apparatus may perform a data traffic (or APP data traffic) aggregation, a data traffic (or APP data traffic) steering, or a data traffic (or APP data traffic) switch through an application processor (AP)-based MP-TCP or MP-QUIC to separate the data traffic (or APP data traffic) to the first SIM and the second SIM.

According to an implementation of the present disclosure, the apparatus may perform a data traffic aggregation, a data traffic steering, or a data traffic switch through an MD upper layer protocol (i.e., MD internal upper layer protocol) or an AP upper layer application (i.e., AP internal upper layer application). That is, each upper-layer protocol or each upper-layer application may manage corresponding traffic dispatch and monitoring.

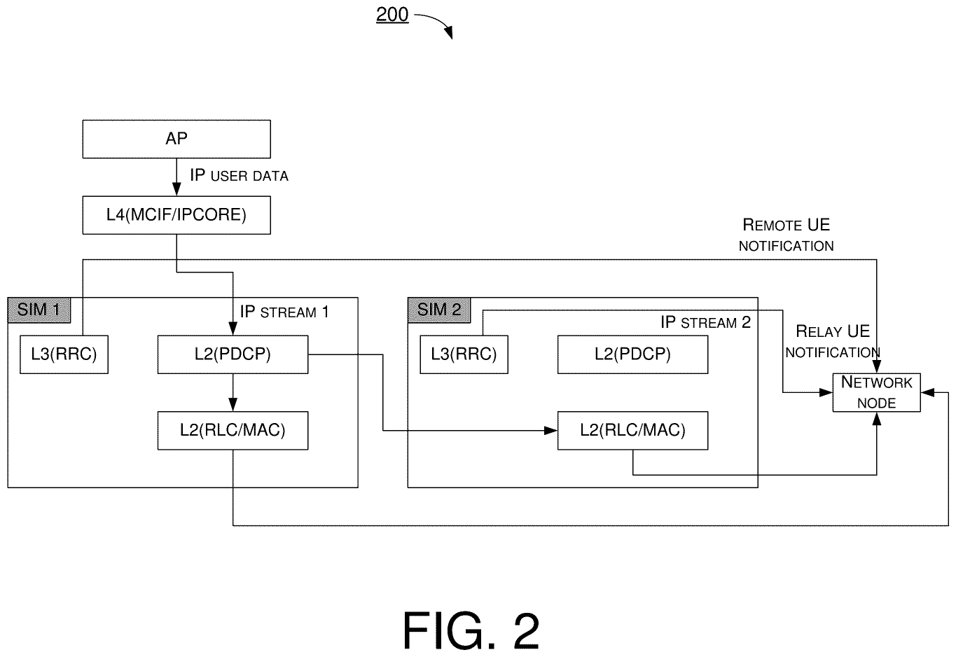

FIG. 2 illustrates an example scenario 200 for multi-SIM data service transmission in accordance with implementations of the present disclosure. Scenario 200 involves an apparatus (e.g., a UE) with multi-SIM transmission capability and a network node (e.g., a (macro/micro) base station) of a wireless network (e.g., an LTE network, a 5G/NR network, an IoT network, or a 6G network). Referring to FIG. 2, the first SIM (e.g., SIM 1) of the apparatus can be considered a remote UE, and the second SIM (e.g., SIM 2) of the apparatus can be considered a relay UE. The application processor (AP) of the apparatus may dispatch the Internet Protocol (IP) user data (e.g., IP stream 1 and IP stream 2) to the first SIM (e.g., SIM 1) and the second SIM (e.g., SIM 2) through MP-TCP or MP-QUIC. In addition, the first SIM may communicate with the second SIM through software/internal protocol (e.g., the layer 2 (L2) signaling between the first SIM and the second SIM).

Referring to FIG. 2, the first SIM (e.g., SIM 1) may establish an RRC connection with the network node (e.g., a gNB) to report the remote UE notification, including the capability of the remote UE function, to the network node. Additionally, the second SIM (e.g., SIM 2) may establish the RRC connection with the network node to report the relay UE notification, including the capability of the relay UE function, to the network node. Then, the apparatus may trigger the UE assisting information transmission through the first SIM (e.g., SIM 1) to transmit relay UE-relevant information to the network node. In addition, the network node may perform an RRC reconfiguration to the second SIM (e.g., SIM 2) to establish a relaying DRB for the second SIM to start the data service. Then, the first SIM (e.g., SIM 1) and the second SIM (e.g., SIM 2) may perform the data service with the network node (e.g., gNB) in the same apparatus.

According to an implementation of the present disclosure, the remote UE notification may comprise a remote identification (ID), and the relay UE notification may comprise a relay ID. The remote ID may be the same as the relay ID. That is, in the implementation, for a paging service, the network node may determine that the remote UE (i.e., the first SIM) and the relay UE (i.e., the second SIM) are the same device in an event that the remote ID in the remote UE notification and the relay ID in the relay UE notification are the same.

According to an implementation of the present disclosure, the remote UE notification and the relay UE notification may comprise the same UE capability (e.g., beam combinations, carrier aggregation (CA), etc.). Different apparatuses may have different UE capabilities. Therefore, in the implementation, for a paging service, the network node may determine that the remote UE (e.g., the first SIM) and the relay UE (e.g., the second SIM) are the same device in an event that the remote UE notification and the relay UE notification comprise the same UE capability.

According to an implementation of the present disclosure, the apparatus may monitor a paging occasion of the first SIM. The apparatus may receive a paging message from the network node through the paging occasion of the first SIM. Then, the apparatus may transmit a paging response to the network node through the second SIM. Therefore, in the implementation, for a paging service, the network node may determine that the remote UE and the relay UE are the same UE since the paging transmission and reception are performed through the first SIM and the second SIM of the apparatus.

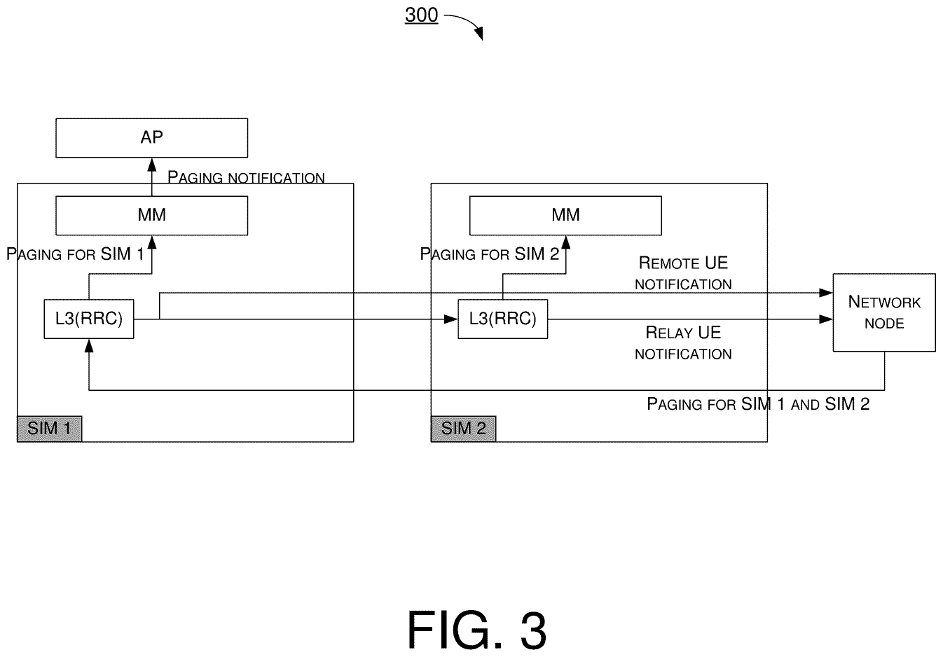

FIG. 3 illustrates an example scenario 300 for multi-SIM paging service (or group paging service) transmission in accordance with implementations of the present disclosure. Scenario 300 involves an apparatus (e.g., a UE) with multi-SIM transmission capability and a network node (e.g., a (macro/micro) base station) of a wireless network (e.g., an LTE network, a 5G/NR network, an IoT network, or a 6G network). Referring to FIG. 3, the first SIM (e.g., SIM 1) of the apparatus can be considered a remote UE, and the second SIM (e.g., SIM 2) of the apparatus can be considered a relay UE. The mobility management (MM) may transmit the paging notification through the first SIM (e.g., SIM 1) and/or the second SIM (e.g., SIM 2) to the AP of the apparatus.

Referring to FIG. 3, the first SIM (e.g., SIM 1) may establish an RRC connection with the network node (e.g., a gNB) to report the remote UE notification, including the capability of the remote UE function, to the network node. Additionally, the second SIM (e.g., SIM 2) may establish the RRC connection with the network node to report the relay UE notification, including the capability of the relay UE function, to the network node. Then, the apparatus may trigger the UE assisting information transmission through the first SIM (e.g., SIM 1) to transmit relay UE-relevant information to the network node. The network node may group the first SIM and the second SIM for the same paging group. The network node may transmit the paging message to the second SIM through the paging occasion of the first SIM. Thus, the apparatus may only need to monitor the paging occasion of the first SIM. Hence, the first SIM and the second SIM may receive the paging message through the paging resource of the remote UE (i.e., first SIM).

According to the implementations of the present disclosure, the UE aggregation and multi-input multi-output (MIMO) aggregation can be realized in one device with a multi-SIM function. In addition, the multi-SIM paging monitoring provided in the implementations of the present disclosure may reduce the power consumption. In addition, in the implementations of the present disclosure, the first SIM and the second SIM may be regarded as the same IP for the APP layer. Thus, the UE aggregation application can be widely extended and implemented.

### Illustrative Implementations

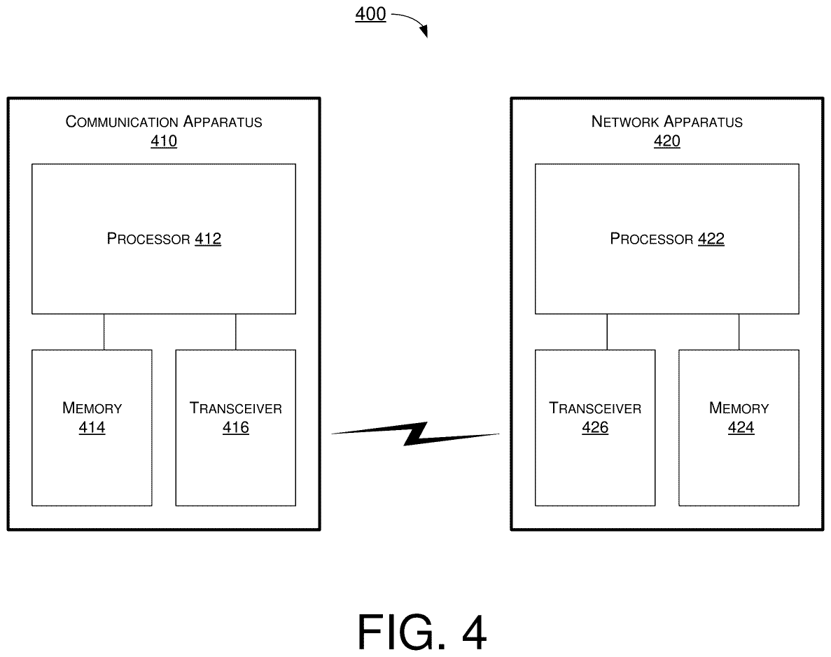

FIG. 4 illustrates an example communication system 400 having at least an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to multi-SIM data transmission for UE grouping, including the various schemes described above with respect to various proposed designs, concepts, schemes and methods described above and with respect to user equipment and network apparatus in mobile communications, including scenarios/schemes described above as well as process 500 and process 600 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 410 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed schemes of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus, which may be a network node such as a satellite, a BS, a small cell, a router or a gateway of an IoT network. For instance, network apparatus 420 may be implemented in a satellite or an eNB/gNB/TRP in a 4G/5G/B5G/6G, NR, IoT, NB-IoT or IIoT network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks, including multi-SIM data transmission for UE grouping, in a device (e.g., as represented by communication apparatus 410) and a network node (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, transceiver 416 may be capable of wirelessly communicating with different types of UEs and/or wireless networks of different radio access technologies (RATs). In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, network apparatus 420 may also include a transceiver 426 coupled to processor 422. Transceiver 426 may include a transceiver capable of wirelessly transmitting and receiving data. In some implementations, transceiver 426 may be capable of wirelessly communicating with different types of UEs of different RATs. In some implementations, transceiver 426 may be equipped with a plurality of antenna ports (not shown) such as, for example, four antenna ports. That is, transceiver 426 may be equipped with multiple transmit antennas and multiple receive antennas for MIMO wireless communications.

In some implementations, communication apparatus 410 may further include a memory 414 coupled to processor 412 and capable of being accessed by processor 412 and storing data therein. In some implementations, network apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 410 and network apparatus 420 may be a communication entity capable of communicating with each other using various proposed schemes in accordance with the present disclosure. For illustrative purposes and without limitation, descriptions of capabilities of communication apparatus 410, as a UE, and network apparatus 420, as a network node (e.g., TRP), are provided below with process 500 and process 600.

### Illustrative Processes

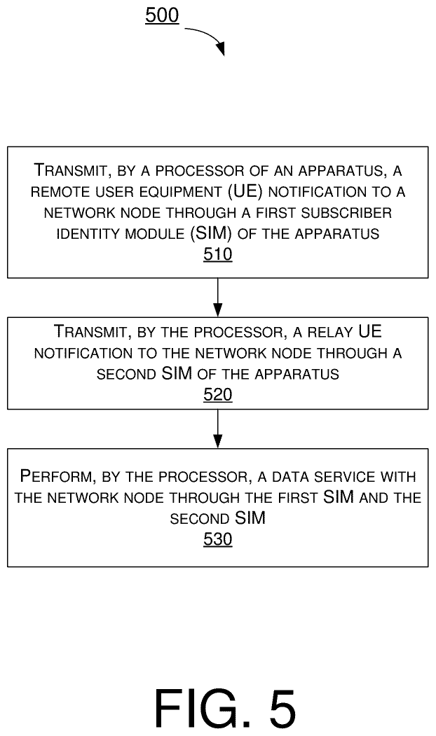

FIG. 5 illustrates an example process 500 in accordance with an implementation of the present disclosure. Process 500 may be an example implementation of above scenarios/schemes, whether partially or completely, with respect to multi-SIM data transmission for UE grouping with the present disclosure. Process 500 may represent an aspect of implementation of features of communication apparatus 410. Process 500 may include one or more operations, actions, or functions as illustrated by one or more of blocks 510, 520, and 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Solely for illustrative purposes and without limitation, process 500 is described below in the context of communication apparatus 510. Process 500 may begin at block 510.

At block 510, process 500 may involve processor 412 of communication apparatus 410 transmitting, via transceiver 416, a remote UE notification to a network node through a first SIM of communication apparatus 410 communication apparatus 410. Process 500 may proceed from block 510 to block 520.

At block 520, process 500 may involve processor 412 of communication apparatus 410 transmitting, via transceiver 416, a relay UE notification to the network node through a second SIM of communication apparatus 410. Process 500 may proceed from block 520 to block 530.

At block 530, process 500 may involve processor 412 of communication apparatus 410 performing a data service with the network node through the first SIM and the second SIM.

In some implementations, the remote UE notification may comprise a capability of a remote UE function. The relay UE notification may comprise a capability of a relay UE function.

In some implementations, process 500 may involve processor 412 triggering a UE assisting information transmission through the first SIM to transmit relay UE relevant information to the network node.

In some implementations, process 500 may involve processor 412 performing a data traffic aggregation, a data traffic steering, or a data traffic switch through an MD-based MP-TCP or MP-QUIC, or an AP-based MP-TCP or MP-QUIC.

In some implementations, process 500 may involve processor 412 performing a data traffic aggregation, a data traffic steering, or a data traffic switch through an MD upper layer protocol or an AP upper layer application.

In some implementations, the remote UE notification comprises a remote ID and the relay UE notification comprises a relay ID, and wherein the remote ID is the same as the relay ID.

In some implementations, the remote UE notification and the relay UE notification may comprise a same UE capability.

In some implementations, process 500 may involve processor 412 monitoring a paging occasion of the first SIM. Process 500 may involve processor 412 receiving, by transceiver 416, a paging message from the network node through the paging occasion of the first SIM. Process 500 may involve processor 412 transmitting, via transceiver 416, a paging response to the network node through the second SIM.

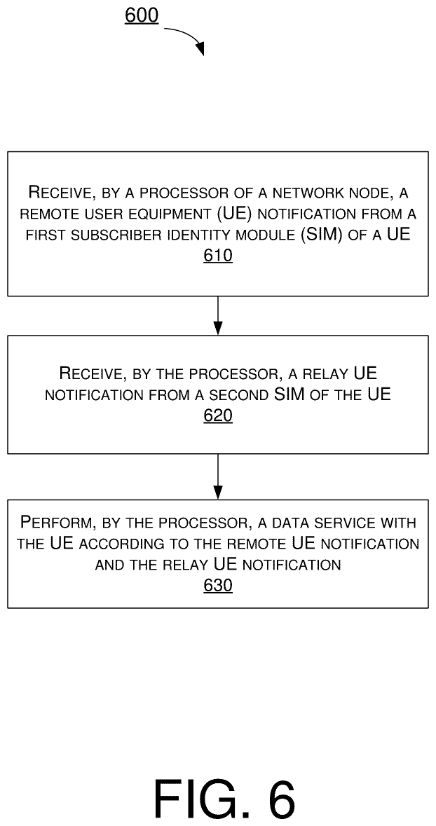

FIG. 6 illustrates an example process 600 in accordance with another implementation of the present disclosure. Process 600 may be an example implementation of above scenarios/schemes, whether partially or completely, with respect to multi-SIM data transmission for UE grouping with the present disclosure. Process 600 may represent an aspect of implementation of features of network apparatus 420. Process 600 may include one or more operations, actions, or functions as illustrated by one or more of blocks 610, 620, and 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Solely for illustrative purposes and without limitation, process 600 is described below in the context of network apparatus 420. Process 600 may begin at block 610.

At block 610, process 600 may involve processor 422 of network apparatus 420 receiving, via transceiver 426, a remote UE notification from a first SIM of a UE. Process 600 may proceed from block 610 to block 620.

At block 620, process 600 may involve processor 422 receiving, via transceiver 426, a relay UE notification from a second SIM of the UE. Process 600 may proceed from block 620 to block 630.

At block 630, process 600 may involve processor 422 performing a data service with the UE according to the remote UE notification and the relay UE notification.

In some implementations, the remote UE notification may comprise a capability of a remote UE function. The relay UE notification may comprise a capability of a relay UE function.

In some implementations, process 600 may involve processor 422 performing an RRC reconfiguration to the second SIM to establish a relaying DRB for the data service.

In some implementations, process 600 may involve processor 422 determining that a remote UE and a relay UE are the same device in an event that a remote ID in the remote UE notification and a relay ID in the relay UE notification are the same.

In some implementations, process 600 may involve processor 422 determining that a remote UE and a relay UE are the same device in an event that the remote UE notification and the relay UE notification comprise the same UE capability.

In some implementations, process 600 may involve processor 422 transmitting, via transceiver 426, a paging message to the UE through a paging occasion of the first SIM of the UE. Process600 may involve processor 422 receiving, via transceiver 426, a paging response from the UE through the second SIM of the UE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus, a remote user equipment (UE) notification to a network node through a first subscriber identity module (SIM) of the apparatus;
transmitting, by the processor, a relay UE notification to the network node through a second SIM of the apparatus; and
performing, by the processor, a data service with the network node through the first SIM and the second SIM.

2. The method of claim 1, wherein the remote UE notification comprises a capability of a remote UE function, and wherein the relay UE notification comprises a capability of a relay UE function.

3. The method of claim 1, further comprising:
triggering, by the processor, a UE assisting information transmission through the first SIM to transmit relay UE relevant information to the network node.

4. The method of claim 1, further comprising:
performing, by the processor, a data traffic aggregation, a data traffic steering, or a data traffic switch through a modem (MD)-based multipath-transmission control protocol (MP-TCP) or multipath-quick user-datagram-protocol (UDP) internet connections (MP-QUIC), or an application processor (AP)-based MP-TCP or MP-QUIC.

5. The method of claim 1, further comprising:
performing, by the processor, a data traffic aggregation, a data traffic steering, or a data traffic switch through a modem (MD) upper layer protocol or an application processor (AP) upper layer application.

6. The method of claim 1, wherein the remote UE notification comprises a remote identification (ID) and the relay UE notification comprises a relay ID, and wherein the remote ID is the same as the relay ID.

7. The method of claim 1, wherein the remote UE notification and the relay UE notification comprise a same UE capability.

8. The method of claim 1, further comprising:
monitoring, by the processor, a paging occasion of the first SIM;
receiving, by the processor, a paging message from the network node through the paging occasion of the first SIM; and
transmitting, by the processor, a paging response to the network node through the second SIM.

9. A method, comprising:
receiving, by a processor of a network node, a remote user equipment (UE) notification from a first subscriber identity module (SIM) of a UE;
receiving, by the processor, a relay UE notification from a second SIM of the UE; and
performing, by the processor, a data service with the UE according to the remote UE notification and the relay UE notification.

10. The method of claim 9, wherein the remote UE notification comprises a capability of a remote UE function, and wherein the relay UE notification comprises a capability of a relay UE function.

11. The method of claim 9, further comprising:
performing, by the processor, a radio resource control (RRC) reconfiguration to the second SIM to establish a relaying data radio bearer (DRB) for the data service.

12. The method of claim 9, further comprising:
determining, by the processor, that a remote UE and a relay UE are a same device in an event that a remote identification (ID) in the remote UE notification and a relay ID in the relay UE notification are the same.

13. The method of claim 9, further comprising:
determining, by the processor, that a remote UE and a relay UE are a same device in an event that the remote UE notification and the relay UE notification comprise a same UE capability.

14. The method of claim 9, further comprising:
transmitting, by the processor, a paging message to the UE through a paging occasion of the first SIM of the UE; and
receiving, by the processor, a paging response from the UE through the second SIM of the UE.

15. An apparatus, comprising:
a first subscriber identity module (SIM);
a second SIM;
a transceiver which, during operation, wirelessly communicates with at least one network node of a wireless network; and
a processor communicatively coupled to the transceiver such that, during operation, the processor performs operations comprising:
transmitting, via the transceiver, a remote user equipment (UE) notification to a network node through the first SIM;
transmitting, via the transceiver, a relay UE notification to the network node through the second SIM; and
performing a data service with the network node through the first SIM and the second SIM.

16. The apparatus of claim 15, wherein the remote UE notification comprises a capability of a remote UE function, and wherein the relay UE notification comprises a capability of a relay UE function.

17. The apparatus of claim 15, wherein the processor performs operations further comprising:
performing a data traffic aggregation, a data traffic steering, or a data traffic switch through a modem (MD)-based multipath-transmission control protocol (MP-TCP) or multipath-quick user-datagram-protocol (UDP) internet connections (MP-QUIC), or an application processor (AP)-based MP-TCP or MP-QUIC, or
performing, by the processor, the data traffic aggregation, the data traffic steering, or the data traffic switch through an MD upper layer protocol or an AP upper layer application.

18. The apparatus of claim 15, wherein the remote UE notification comprises a remote identification (ID) and the relay UE notification comprises a relay ID, and wherein the remote ID is the same as the relay ID.

19. The apparatus of claim 15, wherein the remote UE notification and the relay UE notification comprise a same UE capability.

20. The apparatus of claim 15, wherein the processor performs operations further comprising:
monitoring, via the transceiver, a paging occasion of the first SIM;
receiving, via the transceiver, a paging message from the network node through the paging occasion of the first SIM; and
transmitting, via the transceiver, a paging response to the network node through the second SIM.
